(19) United States
(12) Patent Application Publication
(10) Pub. No.: US 2022/0048702 A1
(43) Pub. Date: Feb. 17, 2022

(54) Tea bag attached to a string made of dental floss - string can be used to floss your teeth after you use it to make tea.

(71) Applicant: Jay Cannold, New York, NY (US)

(72) Inventor: Jay Cannold, New York, NY (US)

(21) Appl. No.: 16/995,623

(22) Filed: Aug. 17, 2020

(51) Int. Cl. B65D 85/812; A61C 15/04; A61C 15/02

(52) U.S. Cl. CPC B65D 85/812; A61C 15/02; A61C 15/043

(57) ABSTRACT

Tea bag attached to a string made of dental floss, string can be used to floss your teeth after you use it to make tea. Dental floss is designed for teeth, string is not.

### BACKGROUND OF THE INVENTION

Problem Solved: Flossing Teeth after having a Meal

String is not dental floss designed to be used on teeth and breaks when used as dental floss, Dental floss is designed for teeth, string is not. After many times using tea bag string from take out food orders to floss my teeth, I have decided it would be best to invent a tea bag that has a string made from dental floss and can be used as such. It would be great for take out, camping trips, lunch boxes, military MREs and many other uses. As drawn and described the invention can also come with specified variations in terms of steeping products (i.e. coffee, soup, infused products), as well as alternative attachments in lieu of the tag (i.e. toothpick, dental tool).

### BRIEF DESCRIPTION OF THE INVENTION

As stated above, flossing teeth after having a meal. The invention claimed here solves this problem.

It makes the string of the tea bag useful for flossing your teeth and steeping your tea.

The claimed invention differs from what currently exists. A tea bag string is not designed to floss teeth, and should be replaced by actual dental floss for alternative usage.

This invention is an improvement on what currently exists. A tea bag string is not designed to floss teeth, and should be replaced by actual dental floss for alternative usage

Using actual dental floss for its designed purpose will work more safely.

Dental floss is designed for teeth, string is not.

### BRIEF DESCRIPTION OF THE DRAWINGS

FIG. 1. Tea bag (B) or alternative steeping products such as coffee or other infused products attached to a string made of dental floss (A) attached to a Tea Tag (C)—string is made of dental floss and can be used to floss your teeth after you use it to make tea.

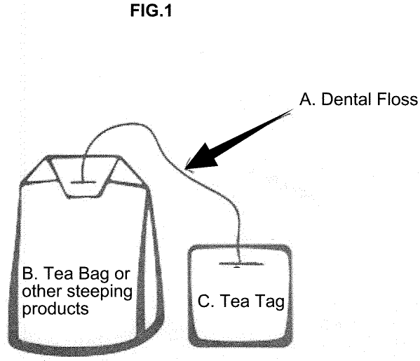

FIG. 2. Tea bag (B) or alternative steeping products such as coffee or other infused products attached to a string made of dental floss (A) attached to a Tea Tag (C)—a supply of additional dental floss is contained in either a Tea Bag floss supply compartment (D) or Tea Tag floss supply compartment (E) or both (D) and (E). String is made of dental floss and can be used to floss your teeth after you use it to make tea.

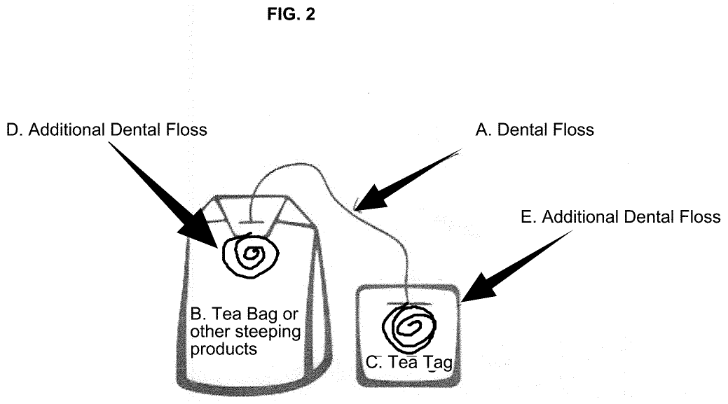

FIG. 3. Tea bag (B) or alternative steeping products such as coffee or other infused products attached to a string made of dental floss (A) attached to a dental implement (F) such as a toothpick or similar on the other end in lieu of a paper tag. String is made of dental floss and can be used to floss your teeth after you use it to make tea.

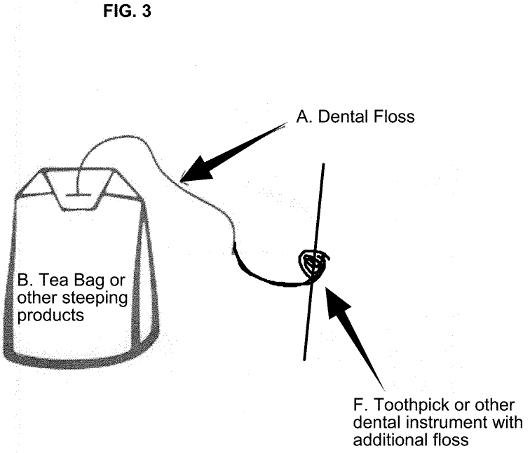

### RELATIONSHIP BETWEEN THE COMPONENTS

Tea bag string is made from dental floss or similar material, that is safe for dental floss usage.

### How the Invention Works:

A tea bag attached to a string made of dental floss material may be used to make tea and to floss your teeth.

How to make the Invention:

Attach tea bag to tea bag label with dental floss material and variations of lengths of floss enclosed in the label.

Tea bag, tea bag label, dental floss, and variations of lengths of floss enclosed in the label. It is possible to add dental floss length to the bag end or the label end, as well as other dental instruments to achieve the same intended purpose.

### How to use the Invention:

A person could use the floss tea bag to make tea and then floss teeth after the tea is made Additionally: if there are other steeping products similarly served in a tea bag that would be served or included with a meal when people are most likely to need dental floss.

What is claimed is:

1. Tea bag or alternative steeping products such as coffee or other infused products attached to a string made of dental floss—string can be used to floss your teeth after you use it to make tea.

2. Tea bag of claim 1, with additional supply of dental floss contained in either the tea bag, tea tag or both.

3. Tea Bag of claim 1, attached to a string made of dental floss on one end and attached to a dental implement such as a toothpick or similar on the other end in lieu of a paper tag.
